(19) United States
(12) Patent Application Publication
(10) Pub. No.: US 2009/0202815 A1
(43) Pub. Date: Aug. 13, 2009

(54) USE OF A NANOSTRUCTURED MATERIAL, AS PROTECTIVE COATING OF METAL SURFACES

(75) Inventors: Elisa Campazzi, Boulogne Billancourt (FR); Valerie Goletto, Paris (FR); Clement Sanchez, Bures-sur Yvette (FR)

Correspondence Address: OBLON, SPIVAK, MCCLELLAND MAIER & NEUSTADT, P.C., 1940 DUKE STREET, ALEXANDRIA, VA, 22314, US

(73) Assignees: EURO. AERONAUTIC DEFENCE AND SPACE CO. EADS FRANCE, Paris (FR); UNIVERSITE PARIS 6 PIERRE ET MARIE CURIE, Paris Cedex 05 (FR); CENTRE NATIONAL DE LA RECHERCHE SCIENT. (CNRS), Paris Cedex 16 (FR)

(21) Appl. No.: 12/297,130

(22) PCT Filed: Apr. 12, 2007
(86) PCT No.: PCT/FR2007/051098

§ 371 Date: Mar. 9, 2009

(30) Foreign Application Priority Data
Apr. 13, 2006 (FR) 0603306

(51) Int. Cl. B32B 5/16; B05D 1/02; B05D 1/28; B05D 3/12; B05D 1/18

(52) U.S. Cl. 428/328; 106/14.44; 252/389.1; 428/338; 427/427.5; 427/421.1; 427/429; 427/240; 427/435

(57) ABSTRACT

The present invention relates to the use of a nanostructured material, as a protective coating for metallic surfaces, said nanostructured material comprising functionalized nano-building blocks and a polymer or hybrid organic/inorganic matrix.

It also relates to a particular nanostructured material in which the matrix is prepared from at least three silicon alkoxides.

The present invention relates to the use of a material comprising at least one nano-building block and a matrix of polymer or hybrid organic/inorganic type, as a component of a protective coating for metallic surfaces, in particular for aeronautic and aerospace applications, and to a particular nanostructured material.

In the aeronautics field, protection against corrosion is generally provided by surface treatments based on chromium VI, for example, using a chromium anodizing method, or conversion coating.

However, chromium VI has been found to be toxic, carcinogenic and dangerous for the environment. In time its use will be prohibited.

There is therefore a need to find another system providing protection, for example, against corrosion but also against scratches or other things, which is at least as high-performance as those that exist.

Hybrid organic/inorganic materials prepared by a sol-gel method have already been envisaged in the art.

For example, document US 2003/024432 describes a coating having anti-corrosive properties, prepared by a sol-gel method from an organometallic salt such as an alkoxy zirconium, an organosilane and one or more compounds bearing a borate, zinc or phosphate functional group, in the presence of an organic catalyst such as acetic acid.

Documents U.S. Pat. No. 6,261,638 and EP 1,097,259 themselves describe methods for preventing metal corrosion, comprising the application of a treatment solution based on polyfunctional silanes and on difunctional silanes that comprise several sulphur atoms in their chain, respectively.

However, these materials have the drawback of not being microstructured or nanostructured, that is to say that the distribution of the organic and inorganic domains in the material cannot be controlled at the micrometric or nanometric level. This random distribution may result in properties that are unreproducible from one material to another.

An advantage of the sol-gel process consists in constructing a three-dimensional network from initial precursors under conditions referred to as gentle conditions, that is to say at a temperature below 200° C., and in a water or water/solvent medium that is less harmful for the environment that those used for conventional surface treatments.

The initial precursors generally used in said sol-gel process are metal alkoxides comprising one or more hydrolysable groups. As examples of metal alkoxides, mention may especially be made of silicon or zirconium alkoxides, alone or as a mixture.

The article “The self-assembled nanophase particle (SNAP) process: a nanoscience approach to coatings”, M. S. Donley el al., Progress in Organic Coatings, 47, 401-415, 2003, describes coatings made from an amorphous material, obtained under gentle conditions, from an aqueous solution comprising tetramethoxysilane and glycidopropyltrimethoxysilane. A corrosion inhibitor is then introduced into the material.

The patent U.S. Pat. No. 6,929,826 describes a method for treating metallic surfaces with an aqueous composition comprising an alkoxysilane, an epoxyalkoxysilane and water. This method comprises, in particular, the steps of mixing the ingredients of the composition, ageing said composition, addition of a crosslinking agent, a surfactant and optionally water, then application of the final composition onto a metallic substrate and drying of said substrate.

The Applicant has discovered, surprisingly, that control of the structure at the nanometric level makes it possible to obtain novel macroscopic properties that are not only the sum of the properties of each of the components, such as mechanical strength, film thickness and quality, density, colouring and hydrophobic character that can be adjusted at will, but are actually novel properties. They result from the synergy of these components at the nanometric level. In addition, this control of the structure at the nanometric level results in a reproducibility of the properties.

This control is achieved thanks to nanostructured composite materials.

The term “nanostructured materials” is understood to mean materials whose structure is controlled at the nanometric level. This structure may be verified especially by X-ray diffraction and small angle X-ray scattering, transmission electron microscopy (TEM) or atomic force microscopy (AFM).

These materials are known from the article “Designed hybrid organic-inorganic nanocomposites from functional nano-building blocks” by C. Sanchez et al., Chem. Mater., 2001, 13, 3061-3083, and are synthesized from well-defined, preferably pre- or post-functionalized, nanometric-sized building blocks (or Nano-Building Blocks (NBBs)) and from a polymer or hybrid organic/inorganic resin.

One part of these materials, such as the matrix obtained by a sol-gel method, is amorphous, whereas the other part is formed from nanometric-sized crystalline domains.

These materials may comprise diverse functionalities that make it possible to give a substrate (or surface), especially an aluminium or titanium alloy for example, protection against corrosion, scratch resistance, good mechanical strength and/or colouring while ensuring good adhesion to the metallic substrate.

In addition, these materials may enable the coexistence of several different functionalities that normally do not coexist, and may be applied by any conventional technique such as, for example, dipping in a bath, spin-coating, spraying or laminar-flow coating and depositing with a brush. The individual components may be formed so as to have a shelf life that is compatible with industrial cycles, for example, greater than or equal to 12 months, and may be mixed just before their application. Their formulation has the additional advantage of using components that are compatible with environmental regulations, and especially of being predominantly in an aqueous medium.

One subject of the present invention is therefore the use of such material as a component of a multifunctional protective coating for metallic surfaces, especially in aeronautics and in aerospace engineering, such as for example for airplane structural components.

This material is formed from nano-building blocks and from a polymer or hybrid organic/inorganic matrix, that is to say a matrix comprising both organic and mineral groups

These nano-building blocks may be in cluster form or in the form of nanoparticles, preferably nanoparticles having a size ranging from 2 to 100 nm, better still from 2 to 50 nm, even better from 2 to 20 nm, more preferably from 2 to 10 nm and even more preferably from 2 to 5 nm, the diameter of these nanoparticles possibly being measured by X-ray diffraction and small angle X-ray scattering, transmission electron microscopy (TEM) or light scattering.

Preferably, the nanoparticles have a size that exhibits a low dispersion.

These nano-building blocks are essentially based on at least one metal oxide, the metal oxide being chosen, for example, from aluminium, cerium III and IV, silicon, zirconium, titanium and tin oxides, even better from zirconium and cerium IV oxides. Several synthesis methods may be used to prepare them.

A first method consists in synthesizing them from metal salts, by precipitation. Complexing agents may be introduced into the reaction medium in order to control the size of the nano-building blocks formed and to ensure their dispersion in the solvent by functionalizing 80 to 100% of the surface of the nanoblocks with monodentate or polydentate complexing agents, such as for example, carboxylic acids, β-diketones, β-ketoesters, α- or β-hydroxy acids, phosphonates, polyamines and amino acids. The weight ratio between the mineral and organic components is especially between 20 and 95%.

The nano-building blocks may also be obtained from at least one metal alkoxide or metal halide via hydrolytic or non-hydrolytic processes. In the case of a hydrolytic process, the controlled hydrolysis is carried out of at least one metal alkoxide or metal halide precursor of general formula:

MZₙ (1);

R′ₓMZₙ₋ₓ (2); or

L^{m}ₓMZₙ₋ₘₓ (3),

formulae (1), (2) and (3) in which:
M represents Al(III), Ce(III), Ce(IV), Si(IV), Zr(IV), Ti(IV) or Sn(IV), preferably Zr(IV) or Ce(IV), the number between brackets being the valency of the metal atom;
n represents the valency of the M atom;
x is an integer ranging from 1 to n−1;
Z represents a halogen atom, such as F, Cl, Br and I, preferably Cl and Br, or —OR;
R represents an alkyl group, preferably comprising 1 to 4 carbon atoms, such as a methyl, ethyl, n-propyl, i-propyl or butyl group, preferably a methyl or ethyl group;
R′ represents a non-hydrolysable group chosen from alkyl groups, especially C₁₋₄ alkyl groups, for example, methyl, ethyl, propyl or butyl groups; alkenyl groups, in particular C₂₋₄ alkenyl groups, such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; methacryl and methacryloxy (C₁₋₁₀ alkyl) groups, such as methacryloxylpropyl groups, and epoxyalkyl or epoxyalkoxyalkyl groups in which the alkyl group is linear, branched or cyclic and is a C₁₋₁₀ alkyl group, and the alkoxy group comprises from 1 to 10 carbon atoms, such as glycidyl and glycidyloxy (C₁₋₁₀ alkyl) groups;
L is a monodentate or polydentate, preferably polydentate, complexing ligand, for example, a carboxylic acid such as acetic acid, a β-diketone such as acetyl acetone, a β-ketoester such as methyl acetoacetate, an α- or β-hydroxy acid such as lactic acid, an amino acid such as alanine, a polyamine such as (3-trimethoxysilylpropyl)diethylenetriamine (DETA), or a phosphonate such as phosphonic acid; and
m represents the degree of hydroxylation of the ligand L, with m=1 when L is a monodentate ligand, and m≧2 when L is a polydentate ligand. Preferably 3≧m≧2 when L is a polydentate ligand.

The term “controlled hydrolysis” is understood to mean a limitation of the growth of species formed by control of the amount of water introduced into the medium and optionally by introducing a complexing agent for the central metal atom, this being in order to reduce the reactivity of the precursors.

The nano-building blocks, preferably in the form of amorphous or crystalline nanoparticles, used in the present invention are surface-functionalized. The functionalization of said nano-building blocks is carried out in the presence of a functionalizing agent, which is a bifunctional molecule, of which one of the functional groups has an affinity for the surface of the nano-building block and the other functional group interacts with the matrix.

Their functionalization is carried out either directly in the course of their synthesis, or in the course of a second step following their synthesis, in the presence of a functionalizing agent, and preferably in the course of a second step. It is referred to as pre- or post-functionalization respectively.

The post-functionalization may be carried out by chemical means, by choosing a bifunctional molecule as the functionalizing agent, of which one of the functional groups has an affinity for the surface of the nano-building block and the other functional group will be able to interact with the matrix but will not have any affinity for the surface of the nano-building block. The functionalization by chemical means thus enables the surface of the nanoblocks to be modified, especially by simple mixing of a solution containing the nano-building blocks with a solution containing the functionalizing agent.

As examples of functional groups having an affinity for the nanoblock surface, mention may especially be made of a carboxylic acid functional group, a diketone functional group or a phosphate or phosphonate functional group, an α- or β-hydroxy acid functional group or a polydentate complex of transition metals.

As examples of functional groups that may interact with the matrix, mention may especially be made of primary, secondary or tertiary amine groups such as C₁₋₈ alkyl amino groups, and polymerizable functional groups such as vinyl, acrylate or methacrylate groups.

As examples of bifunctional molecules used as the functionalizing agent, mention may especially be made of 6-amino-caproic acid and 2-aminoethyl phosphonic acid.

According to the invention, the degree of functionalization is preferably greater than 50%, even better greater than 80%.

Once the nano-building blocks are synthesized and functionalized, they are introduced into a polymer or hybrid inorganic/organic matrix, preferably a hybrid of the sol-gel type, even better based on silica, and even more preferentially made from silica or from silica/zirconium oxide. This matrix will serve as a connector thanks to which the building blocks will form a three-dimensional network.

The hybrid inorganic/organic matrices are typically obtained by polycondensation of at least two metal alkoxides or metal halides in the presence of a solvent, and optionally a catalyst. The metal alkoxides or metal halides used are chosen from those having the general formulae:

M′Z′_{n′} (IV);

R″_{x′}M′ Z′_{n′-x′} (V);

L′_{m′x′}M′ Z′_{m′x′} (VI); and

Z′_{n′-1}M′-R^{′″}-M Z′_{n′-1} (VII),

in which:

n′ represents the valency of the metal atom M′, preferably 3, 4 or 5;

x′ is an integer ranging from 1 to n′−1;

M′ represents a metal atom with a valency of III such as Al; a metal atom with a valency of IV such as Si, Ce, Zr and Ti; or a metal atom with a valency of V such as Nb. Preferably M′ is silicon (n′=4), cerium (n′=4) or zirconium (n′=4), and even more preferentially is silicon;

Z′ represents a hydrolysable group chosen from halogen atoms, for example, F, Cl, Br and I, preferably Cl and Br; alkoxy groups, preferably C₁₋₄ alkoxy groups, such as methoxy, ethoxy, n-propoxy, i-propoxy and butoxy groups; aryloxy groups, in particular C₁₋₁₀ aryloxy groups, such as phenoxy groups; acyloxy groups, in particular C₁₋₄ acyloxy groups such as acetoxy and propionyloxy groups; and C₁₋₁₀ alkylcarbonyl groups, such as acetyl groups. Preferably, Z′ represents an alkoxy group, and more particularly an ethoxy or methoxy group;

R″ represents a monovalent non-hydrolysable group chosen from alkyl groups, preferably C₁₋₄ alkyl groups, for example, methyl, ethyl, propyl and butyl groups; alkenyl groups, in particular C₂₋₄ alkenyl groups such as vinyl, 1-propenyl, 2-propenyl and butenyl groups; alkynyl groups, in particular C₂₋₄ alkynyl groups, such as acetylenyl and propargyl groups; aryl groups, in particular C₆₋₁₀ aryl groups, such as phenyl and naphthyl groups; (meth)acryl and methacryloxy (C₁₋₁₀ alkyl) groups, such as methacryloxy propyl groups; and epoxyalkyl or epoxyalkoxyalkyl groups in which the alkyl group is linear, branched or cyclic and is a C₁₋₁₀ alkyl group, and the alkoxy group comprises from 1 to 10 carbon atoms, such as glycidyl and glycidyloxy (C₁₋₁₀ alkyl) groups. R″ preferably represents a methyl or glycidyloxy(C₁₋₁₀ alkyl) group such as a glycidyloxypropyl group;

R′″ represents a divalent non-hydrolysable group chosen from alkylene groups, preferably C₁₋₄ alkylene groups, for example, methylene, ethylene, propylene and butylene groups; alkenylene groups, in particular C₂₋₄ alkenylene groups, such as vinylene, 1-propenylene, 2-propenylene and butenylene groups; alkynylene groups, in particular C₂₋₄ alkynylene groups, such as acetylenylene and propargylene groups; arylene groups, in particular C₆₋₁₀ arylene groups, such as phenylene and naphthylene groups; methacryl and methacryloxy (C₁₋₁₀ alkylene) groups, such as methacryloxypropyl groups; and epoxyalkyl or epoxyalkoxyalkyl groups in which the alkyl group is linear, branched or cyclic and is a C₁₋₁₀ alkyl group, and the alkoxy group comprises from 1 to 10 carbon atoms, such as glycidyl and glycidyloxy (C₁₋₁₀ alkyl) groups. R′″ preferably represents a methylene or glycidyloxy (C₁₋₁₀ alkyl) group such as a glycidyloxypropyl group; and

L′ represents a complexing ligand as described for L above; and

m′ represents the degree of hydroxylation of the ligand L′, with m′=1 when L′ is a monodentate ligand, and m′≧2 when L′ is a polydentate ligand.

In one preferred embodiment, the matrix is obtained from a mixture of at least three silicon alkoxides:

Si(OR¹)₄;

R²Si(OR¹)₃; and

R³R⁴ Si(OR¹)₂,

in which:

R¹ represents a methyl or ethyl group,

R² and R³ each represent a (meth)acrylate, vinyl, epoxyalkyl or epoxyalkoxyalkyl group in which the alkyl group is linear, branched and/or cyclic, and is a C₁₋₁₀ alkyl group, and the alkoxy group comprises from 1 to 10 atoms, for example the 3,4-epoxycyclohexylethyl or glycidyloxy (C₁₋₁₀ alkyl) group, such as the glycidyloxypropyl group; and

R⁴ represents a C₁₋₁₀ alkyl group, such as a methyl group.

Preferably, the proportion of the R²Si(OR¹)₃ precursor is in the majority, while that of the R³R⁴Si(OR¹)₂ precursor is in the minority, for example from 5 to 30% by weight, even better around 20% by weight, relative to the total weight of the mixture of precursors.

The solvent is predominantly made of water. Preferably, it comprises 80 to 100% by weight of water relative to the total weight of the solvent, and optionally a C₁₋₄ alcohol, preferably ethanol or isopropanol.

The catalyst is preferably an acid, even better acetic acid, or CO₂.

The solution to be deposited is mainly composed of a mixture of silanes, for example from 5 to 30% by weight, preferably around 20% by weight, relative to the total weight of the solution. The molar ratio of acid relative to the silicon is preferentially around 1%. The molar ratios of the functionalized nano-building blocks added relative to the silicon are less than 20%. For example, they are preferentially 5% and 10% for cerium oxide and zirconium oxide respectively.

A nanostructured material according to the invention is prepared, on the one hand:
by preparing the nano-building blocks, especially by a hydrolytic or non-hydrolytic process as described above;
by functionalizing the nano-building blocks; on the other hand:
by preparing the matrix; then
by mixing the functionalized nano-building blocks with the matrix.

At least one additive may optionally be added, either during the preparation of the nano-building blocks, or during the mixing of the functionalized nano-building blocks with the matrix, or during both these steps.

In the case when an additive is added during the preparation of the nano-building blocks, it may form a final material of the core-shell type, the core consisting of the additive and the shell consisting of a nano-building block.

The additives which may be used in the invention are especially surfactants for improving the wettability of the sol onto the metallic substrate, such as non-ionic fluoropolymers sold under the trademarks FC 4432 and FC 4430 by 3M; colorants, for example rhodamine, fluorescein, methylene blue and ethyl violet; crosslinking agents such as (3-trimethoxysilylpropyl)diethylenetriamine; coupling agents such as aminopropyltriethoxysilane (APTS); nanopigments; corrosion inhibitors such as benzotriazole, or mixtures thereof.

Examples of metallic surfaces used for being coated by the nanostructured material described above are titanium, aluminium and their respective alloys, such as for example TA6V titanium, aluminium from the 2000 family, more particularly plated or unplated Al 2024, aluminium from the 7000 family, more particularly Al 7075 or 7175 and aluminium from the 6000 or 5000 family.

The coatings of such metallic surfaces, obtained from nanostructured materials as described above, make it possible, in particular, to obtain protection against corrosion, scratch resistance, colouring and hydrophobic character that can be adjusted at will, while adhering well to the surface of the metallic substrate.

In addition, these coatings are deposited using techniques that are simple to implement on metallic surfaces, for example by dipping in a bath, spin-coating, spraying or laminar-flow coating or depositing with a brush. In addition, these techniques use products that are environmentally friendly.

Another subject of the present invention is a particular nanonstructured material comprising nano-building blocks as described above and a hybrid organic/inorganic matrix prepared from at least three particular metal alkoxides corresponding to the following formulae:

Si(OR¹ )₄;

R²Si(OR¹)₃; and

R³R⁴Si(OR¹)₂,

in which R¹, R², R³ and R⁴ are as defined above.

The particular nanostructured material according to the invention may be prepared according to a method comprising, in particular, the steps consisting in:

on the one hand
a) preparing nano-building blocks by a hydrolytic or non-hydrolytic process from at least one metal alkoxide as described above; and
b) functionalizing the nano-building blocks using a functionalizing agent as described above,
   on the other hand
c) preparing the hybrid organic/inorganic matrix by a sol-gel process, from three silicon alkoxides as defined above, the preparation by a sol-gel process being carried out in the presence of a solvent, and optionally a catalyst as described above;
   then
d) mixing the functionalized nano-building blocks obtained in step b) with the matrix obtained in step c).

At least one additive as described above may optionally be added during step a) or during step d) or during both steps a) and d).

In the case where an additive is added during step a), it may form a final material from step d) of the core/shell type, the core being formed by the additive and the shell being formed by a nano-building block.

This method is carried out under conditions referred to as gentle conditions, that is to say at an ambient temperature of around 20 to 25° C., and at atmospheric pressure.

A further subject of the invention is an article comprising a metallic substrate, for example made from titanium, aluminium or from one of their alloys, and a particular nanostructured material as defined above.

This article according to the invention may be prepared by a conventional coating method that comprises a step of dipping in a bath, spin-coating, spraying or laminar-flow coating or depositing with a brush at least one particular nanostructured material as defined above.

The invention and the advantages that it provides will be better understood thanks to the embodiment examples given below by way of indication.

### EXAMPLES

### Example 1

### Preparation of a NBB-1 Solution by Functionalizing Cerium Oxide Nanoparticles With 6-Aminocaproic Acid

81 mg of 6-aminocaproic acid was dissolved in 1 ml of a colloidal solution of CeO₂ nanoparticles in H₂O, sold under the trademark RHODIGARD W200 by Rhodia. A degree of functionalization r=n_{acid}/n_{CeO2}=0.5 was obtained, measured by thermogravimetric analysis and confirmed by Fourier Transform Infra-Red (FTIR) on powder.

### Example 2

### Preparation of a NBB-2 Solution by Functionalizing Cerium Oxide Nanoparticles With 6-Aminocaproic Acid

162 mg of 6-aminocaproic acid was dissolved in 1 ml of a colloidal solution of CeO₂ nanoparticles in H₂O, sold under the trademark RHODIGARD W200 by Rhodia. A degree of functionalization r=n_{acid}/n_{CeO2}=1 was obtained.

### Example 3

### Preparation of a NBB-3 Solution by Functionalizing Cerium Oxide Nanoparticles With 2-Aminoethylphosphonic Acid

48.75 mg of 2-aminoethylphosphonic acid was added to 1 ml of the solution sold under the trademark RHODIGARD W200 by Rhodia. A degree of functionalization r=n_{acid}/n_{CeO2}=0.3 was obtained.

### Example 4

### Preparation of a NBB-4 Solution

Added to a solution containing 4.55 g of acetylacetone and 13.75 g of 1-propanol were, 18.67 g of zirconium tetraisopropoxide as a 70 wt % solution in 1-propanol. Added to the previous mixture, stirred at room temperature, was a solution containing 6.01 g of para-toluenesulphonic acid and 7.895 g of water. The solution was stirred for 5 minutes at room temperature then the flask containing the solution was sealed and it was left for 24 h in an oven at 60° C.

### Example 5

### Preparation of an NBB-5 Solution by Functionalizing Zirconium Oxide Nanoparticles With 6-Aminocaproic Acid

Added to 5 ml of the NBB-4 solution described above were 524 mg of 6-aminocaproic acid. The solution was left stirring until the amino acid had completely dissolved, which required around 12 hours.

For the Examples 1 to 5 above, the hydrodynamic diameter of the functionalized particles obtained was estimated, by light scattering, as being between 2 and 10 nm.

### Example 6

### Preparation of a Solution Containing the Wetting Agent Sold Under the Trademark FC-4432 by 3M

A 10 wt % solution of the wetting agent in isopropanol was prepared.

### Example 7

### NBB-2+GPTMS/TMOS/GMDES matrix (molar ratio=2.5/1/0.5).

Added dropwise, with stirring, at room temperature, to 6.4 ml of an acetic acid solution (0.05 mol/l (or M)) was the mixture of 0.93 g of tetramethoxysilane (TMOS), 3.734 g of 3-glycidoxypropyl-trimethoxysilane (GPTMS) and 0.77 g of 3-glycidoxypropylmethyl-diethoxysilane (GMDES).

The solution continued to be stirred at room temperature in a sealed flask for 6 days. Introduced into the mixture, on the 6^{th} day, was the NBB-2 solution prepared in Example 2, in an amount such that the Ce/Siₜₒₜ molar ratio was 0.05. A clear yellow-coloured solution (A) was thus obtained, which continued to be stirred.

Added to the solution (A), a few minutes before depositing a film, was a given amount of the wetting agent solution from Example 6, so as to obtain in the final mixture a weight proportion of 0.04% of wetting agent, relative to the total weight of the mixture.

The substrate made from an unplated Al 2024 T3 alloy was prepared, having dimensions of 125×80×1.6 mm, giving a total surface area of 2 dm², just before the deposition, according to a methodology known to a person skilled in the art such as alkaline cleaning followed by acid etching, with a formulation that is compatible with environmental regulations.

A film was deposited onto the substrate by immersion of the latter in the final mixture for 90 seconds then removal and drying at room temperature.

### Example 8

### NBB-2+GPTMS/TMOS/GMDES matrix (Molar Ratio=2.5/1/0.5)+Colorant

A solution (A) was prepared in the same way as in Example 7. Dissolved in the solution (A) was a given amount of rhodamine B corresponding to a concentration of colorant in the solution of 10⁻³M. Instantly, the solution took on a pronounced pink colour.

Added to the previous solution, a few minutes before depositing the film, was the wetting agent solution from Example 6 so as to obtain a final mixture comprising a proportion of 0.04% by weight of the wetting agent relative to the total weight of the final mixture.

The substrate was prepared just before the deposition in the same way as in Example 7.

A film was deposited onto the substrate by immersion of the latter in the final mixture for 90 seconds then removal and drying at room temperature.

### Example 9

### NBB-2+GPTMS/TMOS/GMDES matrix (Molar Ratio=2.5/1/0.5)

Added dropwise, with stirring at room temperature, to 6.4 ml of an acetic acid solution (0.05M) was the mixture of 0.93 g of tetramethoxysilane (TMOS), 3.734 g of 3-glycidoxypropyltrimethoxy-silane (GPTMS) and 0.49 g of dimethyldiethoxysilane (DMDES).

The solution continued to be stirred at room temperature in a sealed flask for one day. After ageing the sol for one day, the solution of NBB-2 was added in an amount such that the Ce/Siₜₒₜ molar ratio was 0.05. It was left stirring for 30 minutes in order to obtain a solution (B).

Next, the solution containing the wetting agent from Example 6 was added thereto, so as to obtain a wetting agent concentration of 0.04% by weight in the final mixture.

The substrate was prepared just before the deposition in the same way as in Example 7.

A film was deposited on the substrate by immersion of the latter in the final mixture for 90 seconds then removal and drying at room temperature.

### Example 10

### NBB-2+NBB-4+GPTMS/TMOS/DMDES Matrix (Molar ratio=2.5/1/0.5)

A solution (B) was prepared in the same way as in Example 9, then 7 ml of NBB-4 solution was added thereto. It was left stirring for a few minutes in order to obtain the solution (C).

Next, the wetting agent solution from Example 6 was introduced therein so as to obtain a wetting agent concentration of +0.04% by weight in the final mixture.

The substrate was prepared just before the deposition in the same way as in Example 7.

A film was deposited on the substrate by immersion of the latter in the final mixture for 90 seconds then removal and drying at room temperature.

Two test pieces were prepared. After drying one of them for 24 h at room temperature, it was treated at 110° C. for 30 minutes.

### Example 11

### NBB-2+NBB-4+GPTMS/TMOS/DMDES Matrix (Molar Ratio=2.5/1/0.5)+Diethylenetriamine (DETA) Crosslinking Agent

A solution (C) was prepared in the same way as in Example 10.

Next, 576 mg of DETA was added to the solution (C), then a few minutes later, the wetting agent solution from Example 6 was added so as to obtain a wetting agent concentration of 0.04% by weight in the final mixture.

The substrate was prepared just before the deposition in the same way as in Example 7.

A film was deposited on the substrate by immersion of the latter in the final mixture for 90 seconds then removal and drying at room temperature.

Two test pieces were prepared. After drying one of them for 24 h at room temperature, it was treated at 110° C. for 30 minutes.

### Example 12

### NBB-2+NBB-4+GPTMS/TMOS/DMDES Matrix (Molar Ratio=2.5/1/0.5)+Aminopropyltriethoxysilane (APTS) Coupling Agent

A solution (C) was prepared in the same way as in Example 10. Next, 3.2 g of APTS was introduced, then a few minutes later, the wetting agent solution from Example 6 was introduced so as to obtain a wetting agent concentration of 0.04% by weight in the final mixture.

The substrate was prepared just before the deposition in the same way as in Example 7.

A film was deposited on the substrate by immersion of the latter in the final mixture for 90 seconds then removal and drying at room temperature.

Two test pieces were prepared. After drying one of them for 24 h at room temperature, it was treated at 110° C. for 30 minutes.

### Example 13

### NBB-3+GPTMS/TMOS/DMDES Matrix (Molar Ratio=2.5/1/0.5)

Added dropwise, with stirring at room temperature, to 6.4 ml of an acetic acid solution (0.05M) was the mixture of 0.93 g of tetramethoxysilane (TMOS), 3.734 g of 3-glycidoxypropyltrimethoxy-silane (GPTMS) and 0.49 g of dimethyldiethoxysilane (DMDES). 30 minutes later, 1 ml of NBB-3 solution was introduced. It was left to stir at room temperature for 24 h. It was deposited onto the substrate by spin-coating rotating at 1500 rpm, and it was left to dry at room temperature.

### Example 14

### NBB-5+GPTMS/TMOS/DMDES Matrix (Molar Ratio=2.5/1/0.5)

Added dropwise, with stirring at room temperature, to 6.4 ml of an acetic acid solution (0.05M) was the mixture of 0.93 g of tetramethoxysilane (TMOS), 3.734 g of 3-glycidoxypropyltrimethoxy-silane (GPTMS) and 0.49 g of dimethyldiethoxysilane (DMDES). As soon as the solution was clear and homogeneous, that is to say after a few minutes, 3.5 ml of NBB-5 solution was introduced. It was left to stir at room temperature. Two hours later, it was deposited onto the substrate by spin-coating rotating at 1500 rpm, and it was left to dry at room temperature.

### Example 15

### NBB-4+NBB-5+GPTMS/TMOS/DMDES Matrix (Molar Ratio=2.5/1/0.5)

Added dropwise, with stirring at room temperature, to 6.4 ml of an acetic acid solution (0.05M) was the mixture of 0.93 g of tetramethoxysilane (TMOS), 3.734 g of 3-glycidoxypropyltrimethoxy-silane (GPTMS) and 0.49 g of dimethyldiethoxysilane (DMDES). 30 minutes later, 3.5 ml of NBB-4 solution was introduced. It was left to stir at room temperature for 24 h. 1 ml of NBB-5 solution was then added to the previous mixture. It was left stirring for 2 h. Next it was deposited onto the substrate by spin-coating rotating at 1500 rpm, and it was left to dry at room temperature.

In Examples 7 to 15, films having thicknesses ranging from 500 nm to several μm, more particularly between 2 and 6 μm, and preferentially between 1.5 and 3 μm, were obtained.

These films have good interface stability, namely between the layer deposited and the metallic substrate, and between the layer deposited and the primary deposition of paint, and also have a good resistance to mechanical stresses such as impact and bending stresses. The corrosion resistance, with or without paint is comparable to that of chromated layers.

1. A nanostructured material, as a protective coating for metallic surfaces, said nanostructured material comprising surface-functionalized nano-building blocks and a polymer or hybrid organic/inorganic matrix, the functionalization of said nano-building blocks being carried out in the presence of a functionalizing agent, which is a bifunctional molecule, of which one of the functional groups has an affinity for the surface of the nano-building block and the other functional group interacts with the matrix.

2. The nanostructured material according to claim 1, wherein the nanoblocks are in cluster form or in the form of nanoparticles.

3. The nanostructured material according to claim 2, wherein the nanoparticles have a size ranging from 2 to 100 nm.

4. The nanostructured material according to claim 3, wherein the nanoparticles have a size ranging from 2 to 50 nm.

5. The nanostructured material according to claim 1, wherein the nano-building blocks are essentially based on at least one metal oxide.

6. The nanostructured material according to claim 5, wherein the metal oxide is chosen from aluminium, cerium III and IV, silicon, zirconium, titanium and tin oxides.

7. The nanostructured material according to claim 6, wherein the metal oxide is chosen from zirconium and cerium IV oxides.

8. The nanostructured material according to claim 1, wherein the nano-building blocks are synthesized from metal salts, by precipitation.

9. The nanostructured material according to claim 1, wherein the nano-building blocks are obtained from at least one metal alkoxide or metal halide via a hydrolytic or non-hydrolytic process.

10. The nanostructured material according to claim 9, wherein the metal alkoxide or metal halide used in a hydrolytic process corresponds to one of the following formulas:
MZₙ (1);
R′ₓMZₙ₋ₓ (2); or
L^{m}ₓMZₙ₋ₘₓ (3),
formulas (1), (2) and (3) in which:
M represents Al(III), Ce(III), Ce(IV), Si(IV), Zr(IV), Ti(IV) or Sn(IV), the number between brackets being the valency of the M atom;
n represents the valency of the M atom;
x is an integer ranging from 1 to n−1;
Z represents a halogen atom or —OR;
R represents an alkyl group, preferably comprising 1 to 4 carbon atoms;
R′ represents a non-hydrolysable group chosen from alkyl groups, especially C₁₋₄ alkyl groups; alkenyl groups, in particular C₂₋₄ alkenyl groups; alkynyl groups, in particular C₂₋₄ alkynyl groups; aryl groups, in particular C₆₋₁₀ aryl groups; methacryl and methacryloxy (C₁₋₁₀ alkyl) groups; and epoxyalkyl or epoxyalkoxyalkyl groups in which the alkyl group is linear, branched or cyclic and is a C₁₋₁₀ alkyl group, and the alkoxy group comprises from 1 to 10 carbon atoms;
L is a monodentate or polydentate, preferably polydentate, complexing ligand; and
m represents the degree of hydroxylation of the ligand L.

11. The nanostructured material according to claim 10, wherein M represents Zr(IV) or Ce(IV).

12. The nanostructured material according to claim 10, wherein R represents a methyl or ethyl group; R′ represents a non-hydrolysable group chosen from methyl, ethyl, propyl, butyl, vinyl, 1 -propenyl, 2 propenyl, butenyl, acetylenyl, propargyl, phenyl, naphthyl, methacryl, methacryloxypropyl, glycidyl and glycidyloxy (C₁₋₁₀ alkyl); and L is a complexing ligand chosen from carboxylic acids, β-diketones, β-ketoesters, α- and β-hydroxy acids, amino acids and phosphonates.

13. The nanostructured material according to claim 1, wherein the functionalization of the nano-building blocks is carried out simultaneously during their synthesis, in the presence of a functionalizing agent.

14. The nanostructured material according to claim 1, wherein the functionalization is carried out during a second step following their synthesis, in the presence of a functionalizing agent.

15. The nanostructured material according to claim 1, wherein the functional group having an affinity for the nanoblock surface is chosen from carboxylic acid, diketone, phosphate, phosphonate and α- or β-hydroxy acid functional groups and a polydentate complexing agent for transition metals.

16. The nanostructured material according to claim 1, wherein the functional group which may interact with the matrix is chosen from primary, secondary and tertiary amine groups and polymerizable functional groups such as vinyl, acrylate or methacrylate groups.

17. The nanostructured material according to claim 1, wherein the functionalizing agent is chosen from 6-amino-caproic acid and 2-aminoethylphosphonic acid.

18. The nanostructured material according to claim 1, wherein the matrix is a hybrid organic/inorganic matrix obtained by polycondensation of at least two metal alkoxides in the presence of a solvent and optionally a catalyst.

19. The nanostructured material according to claim 18, wherein the metal alkoxides or metal salts have the general formulae:
M′Z′ₙ′ (IV);
R″_{x′}M′ Z′_{n′-x′} (V);
L′_{m′x′}M′ Z′_{m′x′} (VI); and
Z′_{n′-1}M′-R′″-M Z′_{n′-1} (VII),
in which:
n′ represents the valency of the metal atom M′, preferably 3, 4 or 5;
x′ is an integer ranging from 1 to n′−1;
M′ represents a metal atom with a valency of III such as Al; with a valency of IV such as Si, Ce, Zr and Ti; or with a valency of V such as Nb;
Z′ represents a hydrolysable group chosen from halogen atoms, alkoxy groups, preferably C₁₋₄ alkoxy groups, aryloxy groups, in particular C₆₋₁₀ aryloxy groups, acyloxy groups, in particular C₁₋₄ acyloxy groups and C₁₋₁₀ alkylcarbonyl groups;
R″ represents a monovalent non-hydrolysable group chosen from alkyl groups, preferably C₁₋₄ alkyl groups; alkenyl groups, in particular C₂₋₄ alkenyl groups; alkynyl groups, in particular C₂₋₄ alkynyl groups; aryl groups, in particular C₆₋₁₀ aryl groups; (meth)acryl and methacryloxy (C₁₋₁₀ alkyl) groups; and epoxy alkyl or epoxyalkoxyalkyl groups in which the alkyl group is linear, branched or cyclic and is a C₁₋₁₀ alkyl group, and the alkoxy group comprises from 1 to 10 carbon atoms;
R′″ represents a divalent non-hydrolysable group chosen from alkylene groups, preferably C₁₋₄ alkylene groups; alkenylene groups, in particular C₂₋₄ alkenylene groups; alkynylene groups, in particular C₂₋₄ alkynylene groups; arylene groups, in particular C₆₋₁₀ arylene groups; methacryl and methacryloxy (C₁₋₁₀ alkylene) groups; and epoxyalkylene or epoxyalkoxyalkyl groups in which the alkyl group is linear, branched or cyclic and is a C₁₋₁₀ alkyl group, and the alkoxy group comprises from 1 to 10 carbon atoms; and
L′ represents a preferably polydentate complexing ligand; and
m′ represents the degree of hydroxylation of the ligand L′.

20. Use according to claim 19, wherein:
n′ is equal to 4;
x′ is an integer ranging from 1 to 3;
M′ represents a silicon, cerium or zirconium atom;
Z′ represents a hydrolysable group chosen from Cl and Br, methoxy, ethoxy, n-propoxy, i-propoxy, butoxy, phenoxy, acetoxy, propionyloxy and acetyl groups;
R″ represents a monovalent non-hydrolysable group chosen from methyl, ethyl, propyl, butyl, vinyl, 1-propenyl, 2-propenyl, butenyl, acetylenyl, propargyl, phenyl, naphthyl, methacryl, methacryloxypropyl, glycidyl and glycidyloxy (C₁₋₁₀ alkyl) groups;
R′″ represents a divalent non-hydrolysable group chosen from methylene, ethylene, propylene, butylene, vinylene, 1-propenylene, 2 propenylene, butenylene, acetylenylene, propargylene, phenylene, naphthylene, methacryl, methacryloxypropyl, glycidyl and glycidyloxy (C₁₋₁₀ alkyl) groups; and
L′ represents a carboxylic acid, a β-diketone, a β-ketoester, an α- or β-hydroxy acid, an amino acid or a phosphonate.

21. The nanostructured material according to claim 18, wherein the solvent is mostly made up of water.

22. The nanostructured material according to claim 21, wherein the solvent comprises 80 to 100% by weight of water relative to the total weight of the solvent, and optionally a C₁₋₄ alcohol.

23. The nanostructured material according to claim 18, wherein the catalyst is an acid, preferably acetic acid, or CO₂.

24. The nanostructured material according to claim 1, used as protective coating in aeronautics and aerospace engineering.

25. Nanostructured material wherein it comprises functionalized nano-building blocks and a hybrid organic/inorganic matrix prepared from at least three metal alkoxides corresponding to the following formulae:
Si(OR¹)₄;
R²Si(OR¹)₃; and
R³R⁴Si(OR¹)₂,
in which:
R¹ represents a methyl or ethyl group,
R² and R³ each represent a (meth)acrylate, vinyl, epoxyalkyl or epoxyalkoxyalkyl group in which the alkyl group is linear, branched and/or cyclic, and is a C₁₋₁₀ alkyl group, and the alkoxy group comprises from 1 to 10 atoms, such as 3,4-epoxycyclohexylethyl or glycidyloxy (C₁₋₁₀ alkyl); and
R⁴ represents a C₁₋₁₀ alkyl group, such as a methyl group.

26. Nanostructured material according to claim 25, wherein the nanoblocks are in cluster form or in the form of nanoparticles.

27. Nanostructured material according to claim 26, wherein the nanoparticles have a size ranging from 2 to 100 nm.

28. Nanostructured material according to claim 27, wherein the nanoparticles have a size ranging from 2 to 50 nm.

29. Nanostructured material according to claim 25, wherein the nano-building blocks are essentially based on at least one metal oxide.

30. Nanostructured material according to claim 29, wherein the metal oxide is chosen from aluminium, cerium III and IV, silicon, zirconium, titanium and tin oxides.

31. Nanostructured material according to claim 30, wherein the metal oxide is chosen from zirconium and cerium IV oxides.

32. Nanostructured material according to claim 25, wherein the nano-building blocks are synthesized from metal salts, by precipitation, or from at least one metal alkoxide or metal halide via a hydrolytic or non-hydrolytic process.

33. Nanostructured material according to claim 25, wherein the nano-building blocks are obtained from at least one metal alkoxide or metal halide via a hydrolytic process, the metal alkoxide corresponding to one of the following formulae:
MZₙ (1);
R′ₓMZₙ₋ₓ (2); or
L^{m}ₓMZₙ₋ₘₓ (3),
formulas (1), (2) and (3) in which:
M represents Al(III), Ce(III), Ce(IV), Si(IV), Zr(IV), Ti(IV) or Sn(IV), the number between brackets being the valency of the metal atom;
n represents the valency of the M atom;
x is an integer ranging from 1 to n−1;
Z represents a halogen atom or —OR;
R represents an alkyl group, preferably comprising 1 to 4 carbon atoms;
R′ represents a non-hydrolysable group chosen from alkyl groups, especially C₁₋₄ alkyl groups; alkenyl groups, in particular C₂₋₄ alkenyl groups; alkynyl groups, in particular C₂₋₄ alkynyl groups; aryl groups, in particular C₆₋₁₀ aryl groups; methacryl and methacryloxy (C₁₋₁₀ alkyl) groups; and epoxyalkyl or epoxyalkoxyalkyl groups in which the alkyl group is linear, branched or cyclic and is a C₁₋₁₀ alkyl group, and the alkoxy group comprises from 1 to 10 carbon atoms;
L is a monodentate or polydentate, preferably polydentate, complexing ligand; and
m represents the degree of hydroxylation of the ligand L.

34. Nanostructured material according to claim 33, wherein the M atom represents Zr(IV) or Ce(IV).

35. Nanostructured material according to claim 33, wherein R represents a methyl or ethyl group; R′ represents a non-hydrolysable group chosen from methyl, ethyl, propyl, butyl, vinyl, 1-propenyl, 2 propenyl, butenyl, acetylenyl, propargyl, phenyl, naphthyl, methacryl, methacryloxypropyl, glycidyl and glycidyloxy (C₁₋₁₀ alkyl) groups; and L is a complexing ligand chosen from carboxylic acids, β-diketones, β-ketoesters, α- and β-hydroxy acids, amino acids and phosphonates.

36. Nanostructured material according to claim 25, wherein the nano-building blocks are surface-functionalized using a functionalizing agent.

37. Nanostructured material according to claim 36, wherein the functionalizing agent is a bifunctional molecule of which one of the functional groups has an affinity for the surface of the nano-building block and the other functional group interacts with the matrix.

38. Nanostructured material according to claim 37, wherein the functional group having an affinity for the nanoblock surface is chosen from carboxylic acid, diketone, phosphate, phosphonate and α- or β-hydroxy acid functional groups and a polydentate complexing agent for transition metals.

39. Nanostructured material according to claim 38, wherein the functional group which may interact with the matrix is chosen from primary, secondary and tertiary amine groups and polymerizable functional groups such as vinyl, acrylate or methacrylate groups.

40. Nanostructured material according to claim 36, wherein the functionalizing agent is chosen from 6 aminocaproic acid and 2-aminoethylphosphonic acid.

41. Method for preparing a nanostructured material according to claim 25, comprising the steps consisting in:
on the one hand
a) preparing nano-building blocks by a hydrolytic or non-hydrolytic process from at least one metal alkoxide or metal halide; and
b) functionalizing the nano-building blocks using a functionalizing agent,
on the other hand
c) preparing the hybrid organic/inorganic matrix by a sol-gel process, from three silicon alkoxides as defined in claim 25, the preparation by a sol-gel process being carried out in the presence of a solvent, and optionally a catalyst;
then
d) mixing the functionalized nano-building blocks obtained in step b) with the matrix obtained in step c).

42. Preparation method according to claim 41, wherein at least one additive is added during step a) or during step d) or during both steps a) and d).

43. Preparation method according to claim 42, wherein an additive is added during step a) and that the final material from step d) is of the core/shell type, the core being formed by the additive and the shell being formed by a nano-building block.

44. Preparation method according to claim 42, wherein the additive is chosen from surfactants in order to improve the wettability of the sol onto the metallic substrate, colorants, crosslinking agents, coupling agents and corrosion inhibitors.

45. Article wherein it comprises a metallic substrate and a nanostructured material according to claim 25.

46. Article according to claim 45, wherein the metallic substrate is made of titanium, aluminium, or from one of their alloys.

47. Method for preparing an article according to claim 45, wherein it comprises a step of dipping in a bath, spin-coating, spraying or laminar-flow coating or depositing using a brush at least one nanostructured material.
